(19) United States
(12) Patent Application Publication
(10) Pub. No.: US 2022/0065619 A1
(43) Pub. Date: Mar. 3, 2022

(54) DIMENSION MEASUREMENT JIG AND DIMENSION MEASUREMENT DEVICE INCLUDING SAME

(71) Applicant: Samsung Electronics Co., Ltd., Gyeonggi-do (KR)

(72) Inventors: Mancheol Kim, Gyeonggi-do (KR); Gangto Lee, Gyeonggi-do (KR)

(21) Appl. No.: 17/523,416

(22) Filed: Nov. 10, 2021

Related U.S. Application Data
(63) Continuation of application No. PCT/KR2020/006125, filed on May 8, 2020.

(30) Foreign Application Priority Data
May 10, 2019 (KR) 10-2019-0054720
Sep. 27, 2019 (KR) 10-2019-0119903

(51) Int. Cl. G01B 11/24; G01B 11/04; G01B 11/06

(52) U.S. Cl. CPC G01B 11/24; G01B 11/06; G01B 11/046; G01B 11/043

(57) ABSTRACT

A jig for measuring dimensions of an object and a device including the jig are provided. A dimension measurement jig includes a jig body including at least one light guide; and a lighting part disposed adjacent to a first surface of the jig body, wherein the light guide comprises: an opening formed at the first surface of the jig body; a first light path changing member for changing the movement path of light provided from the lighting part through the opening; and a second light path changing member for transmitting light incident in one direction, which is provided from the lighting part, and changing the movement path of light incident in other directions.

### CROSS-REFERENCE TO RELATED APPLICATION(S)

This application is a bypass continuation of International Application No. PCT/KR2020/006125, which was filed on May 8, 2020, and is based on and claims priority under 35 U.S.C. § 119 to Korean Patent Application Nos. 10-2019-0054720 and 10-2019-0119903, which were filed in the Korean Intellectual Property Office on May 10, 2019 and Sep. 27, 2019, respectively, the entire disclosure of each of which is incorporated herein by reference.

### BACKGROUND

### 1. Field

The disclosure relates generally to a jig for measuring dimensions of a measurement object and a device including the same.

### 2. Description of Related Art

To measure the shape, dimensions, and position of a measurement object (e.g., a piece of glass), data for the measurement object is obtained using an optical module or microscope, with the measurement object supported using a mold (or jig).

For example, a 3 dimensional (3D)-shaped measurement object such as a thin plate of glass for a portable terminal is measured at its horizontal and vertical sides as viewed from above and is then measured for its thickness, with the measurement object or mold (or jig) rotated.

To be mounted on a portable terminal housing, the 3D-shaped glass should be precisely manufactured according to specific dimensions. Even a slight error in the dimensions of the glass may create a step (or gap) between the glass and the mount, resulting in poor adhesion to the housing, influx of foreign bodies, and/or deterioration of product durability.

Therefore, a manufactured 3D article (measurement object) commonly requires inspection to determine whether its dimensions match predesignated dimensions.

Typically, moving, fixing, or separating the measurement object for such inspection is conducted manually by a worker. Thus, many errors may exist in the measured dimensions (e.g., length and thickness) and a significant time may be consumed for measurement, deteriorating working efficiency. For example, a worker may inspect the length and/or width of a measurement object using a piece of inspection equipment (or test device) and then rotate the measurement object in order to measure the thickness of the measurement object. These two separate operations may require a great deal of work time and/or deteriorate inspection accuracy.

### SUMMARY

The disclosure is made to address at least the above-mentioned problems and/or disadvantages and to provide at least the advantages described below.

An aspect of the disclosure is to provide a measuring jig and a measuring device that enhance working efficiency by easily fastening or separating a measurement object therefrom.

Another aspect of the disclosure is to provide a measuring jig that allows three dimensions of a measurement object to be simultaneously measured using a 2 dimensional (2D) image capturing device by simultaneously implementing a plan image and side image of the measurement object as 2D images.

In accordance with an aspect of the disclosure, a measuring jig is provided, which includes a jig body including at least one light guide and a lighting unit disposed adjacent to a first surface of the jig body, wherein the light guide includes an opening formed in the first surface of the jig body, a first light path changing member configured to change a traveling path of light provided from the lighting unit through the opening, and a second light path changing member configured to transmit the light provided from the lighting unit and incident from a first direction and change a traveling path of light incident from a second direction.

In accordance with another aspect of the disclosure, a measuring jig is provided, which includes a jig body including a through hole and a light guide disposed around at least a portion of the through hole and a lighting unit disposed adjacent to a first surface of the jig body, wherein the light guide includes an opening formed in the first surface of the jig body, a first light path changing member for changing a traveling path of light provided from the lighting unit through the opening, and a second light path changing member for transmitting light provided from the lighting unit and incident from a first direction and changing a traveling path of light incident from a second direction.

In accordance with another aspect of the disclosure, a measuring jig is provided, which includes a first jig body including a first light guide, a second jig body spaced apart from the first jig body and including a second light guide, and a first lighting unit disposed on a first surface of the first jig body and the second jig body, wherein the first light guide and the second light guide are disposed to face each other on two opposite sides of a measurement object when the measurement object is mounted, wherein each of the first light guide and the second light guide includes an opening formed in the first surface of the first jig body and the second jig body, a first light path changing member for changing a traveling path of light provided from the first lighting unit, and a second light path changing member for transmitting light provided from the first lighting unit and incident from a first direction and changing a traveling path of light incident from a second direction.

### BRIEF DESCRIPTION OF DRAWINGS

The above and other aspects, features, and advantages of certain embodiments of the disclosure will be more apparent from the following detailed description taken in conjunction with the accompanying drawings, in which:

FIG. 1 illustrates a measuring device according to an embodiment;

FIG. 2 is an exploded view illustrating a measuring jig according to an embodiment;

FIG. 3 is a cross-sectional view illustrating a measuring jig according to an embodiment;

FIG. 4 illustrates a partial configuration of a measuring jig according to an embodiment;

FIG. 5 illustrates a partial configuration of a measuring jig according to an embodiment;

FIG. 6 illustrates a lighting unit according to an embodiment;

FIG. 7 is a cross-sectional view illustrating a measuring jig according to an embodiment;

FIG. 8A illustrates an example of measuring a measurement object according to an embodiment;

FIG. 8B illustrates light beams traveling in a first direction inside a measuring jig according to an embodiment;

FIG. 8C illustrates light beams traveling in a second direction inside a measuring jig according to an embodiment;

FIG. 9 illustrates a measuring jig according to an embodiment;

FIG. 10 illustrates a 2D image obtained by capturing a measurement object using a measuring device according to an embodiment;

FIG. 11 illustrates a 2D image obtained by capturing a measurement object using a measuring device according to an embodiment;

FIG. 12 illustrates a mount according to an embodiment;

FIG. 13 illustrates a measuring jig according to an embodiment;

FIG. 14 is a cross-sectional view illustrating a measuring jig according to an embodiment;

FIG. 15 illustrates a portion of a measuring jig cut away according to an embodiment;

FIG. 16 illustrates an enlarged perspective view of a section of FIG. 15;

FIG. 17 illustrates a slidable side support member according to an embodiment;

FIG. 18 illustrates a position adjuster of a measuring jig according to an embodiment;

FIG. 19A illustrates positions and angles of a first light path changing member and a second light path changing member of a measuring jig according to an embodiment; and

FIG. 19B illustrates a position of a first light path changing member and an angle of a second light path changing member in a measuring jig being adjusted according to an embodiment.

### DETAILED DESCRIPTION

Various embodiments are described in detail below with reference to the accompanying drawings. In the following description, specific details such as detailed configuration and components are merely provided to assist the overall understanding of these embodiments. As such, various changes may be made to the disclosure, and the present invention may come with a diversity of embodiments. Therefore, it should be appreciated that the disclosure is not limited to the embodiments, and all changes and/or equivalents or replacements thereto also belong to the scope of the disclosure.

In addition, descriptions of well-known functions and constructions are omitted for clarity and conciseness.

The terms as used herein are provided merely to describe some embodiments thereof, but not to limit the disclosure.

Terms including ordinal numbers such as “first” and “second” may be used to denote various components, but the components are not limited by the terms. The terms are used to distinguish one component from another. For example, a first component may be denoted a second component, and vice versa without departing from the scope of the disclosure. The term “and/or” may denote a combination(s) of a plurality of related items as listed or any of the items.

Relative terms, such as “front,” “rear,” “upper,” and “lower,” which are used for elements as they are shown in the drawings, may be replaced with ordinal numbers, such as “first” and “second.” The order denoted by the ordinal numbers, first and second, may vary as necessary.

As used herein, the singular forms “a,” “an,” and “the” are intended to include the plural forms as well, unless the context clearly indicates otherwise. It will be further understood that the terms “comprise” and/or “have,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

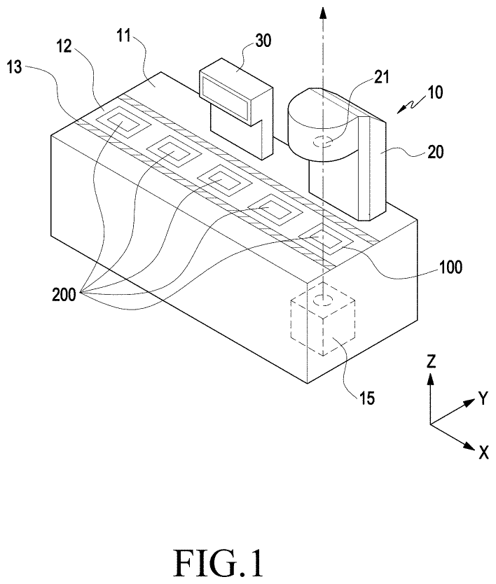

FIG. 1 illustrates a measuring device according to an embodiment.

Referring to FIG. 1, the measuring device 10 may measure a 3D measurement object 200, e.g., a piece of glass for covering a front surface of an electronic device (e.g., a portable terminal). The glass may have a 3D shape and be substantially transparent to transmit light.

According to some embodiments, e.g., a curved portion of a curved display may be disposed on an edge of the front surface of the electronic device (e.g., a portable terminal). Accordingly, the edge of the glass may have a shape corresponding to the curved portion of the curved display. The thickness of the shape (the curved portion of the glass) corresponding to the curved portion of the curved display as well as the length and width of the glass may be measured using the measuring device.

According to various embodiments, the measurement object 200 is not limited to any specific type and may also be formed in various shapes not illustrated in the drawings. For example, the measurement object 200 may be a thin 3D shape, e.g., a housing, protective cover, plate, or bracket of an electronic device.

According to various embodiments, the measuring device 10 includes a platform 11, an optical tower unit 20, and a monitor unit 30.

The platform 11 receives a measuring jig 100. The optical tower unit 20 and the monitor unit 30 may also be arranged on the platform 11, corresponding to the position where the measuring jig 100 is disposed. The measuring jig 100 may be disposed in a designated position on the platform 11.

The optical tower unit 20 includes an optical module 21, e.g., an optical measurement sensor or a camera. The optical module 21 may be spaced apart by a predetermined distance from the measuring jig 100 disposed on the platform 11 and faces the measuring jig in order to obtain an image of the measurement object 200.

According to an embodiment, the optical module 21 may be a component to receive light provided from an external light source. For example, the optical module 21 may be aligned, for the optical axis, with a light source 15 disposed inside the platform 11 to receive the light from the light source 15 through the optical module 21.

According to an embodiment, at least one measuring jig 100 may be positioned in the optical axis direction. For example, FIG. 1 illustrates five measuring jigs 100.

When the measurement object 200 is placed on the measuring jig 100, an image (e.g., a shadow image) of the measurement object 200 may be obtained while the light emitted from the light source 15 is received by the optical module 21. For example, if the measurement object 200 (e.g. glass) is positioned, in parallel with the upper surface of the platform 11, on a seating part of the measuring jig 100, and then, light is emitted from the light source 15 under the glass, a shadow image of the glass may form on the optical module 21. Dimensions (e.g., length, width, and thickness) of the glass may be identified using the so-obtained shadow image.

In the measuring device 10 according to various embodiments of the disclosure, the monitor unit 30 may be disposed, adjacent to the optical tower unit 20, on the upper surface of the platform 11. Although FIG. 1 illustrates a configuration in which a screen is displayed at a predetermined height as the optical tower unit 20, the disclosure is not limited thereto. The monitor unit 30 may be of any type that can provide a user with data related to the measurements of the measurement object 200. The image or video information obtained for the measurement object 200 through the optical module 21 may be provided to the user using the monitor unit 30.

According to various embodiments, an image of the measurement object 200 may be provided to the monitor unit 30 in a 2D form. According to various embodiments of the disclosure, the image of the measurement object 200 provided through the monitor unit 30 may be a plan image for measuring dimensions, such as the length and/or width, of the measurement object 200 or a side image for measuring the thickness of the measurement object 200.

Conventionally, the horizontal and vertical sides, as viewed from above the measurement object 200, are measured first, and then the measurement object or the mold (or jig) is rotated in order to measure the thickness of the side surface of the measurement object 200.

However, according to an embodiment, a plan image and side image of the measurement object 200 may be identified during the same process (or simultaneously) through the monitor unit 30, thereby enhancing work efficiency.

According to various embodiments, the platform 11 further includes a base jig 12 for seating the measuring jig 100. The user may seat and firmly position the measuring jig 100 of the disclosure on the base jig 12 and then perform measurement through an input device (e.g., a central processing unit (CPU) or an integrated measurement controller).

According to various embodiments, the platform 11 further includes a conveyor member 13 for moving the measuring jig 100 in a planar direction. According to various embodiments, the measuring device 10 may perform an inspection operation using the plurality of measuring jigs 100, which may be disposed on the platform 11 in a row, and an inspection operation for a plurality of measurement objects may be performed more quickly using the conveyor member 13.

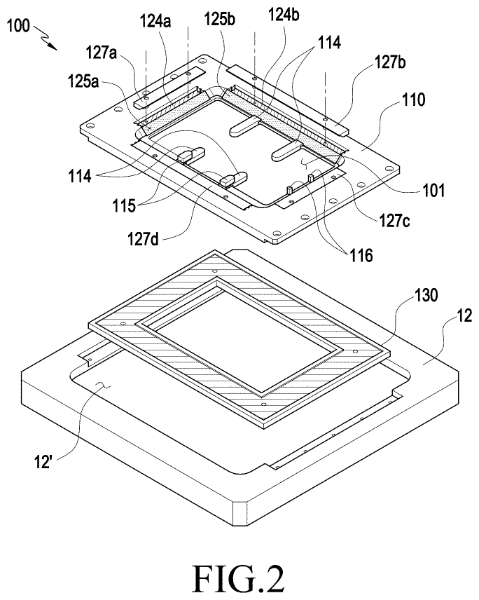

FIG. 2 is an exploded view illustrating a measuring jig according to an embodiment.

According to various embodiments of the disclosure, a mount for mounting the measurement object 200 may be provided, and there may be disclosed a measurement object 200 that may be placed on the measuring device 10.

Referring to FIG. 2, the measuring jig 100 includes a jig body 110 for mounting the measurement object 200 and a lighting unit 130 disposed adjacent to one surface of the jig body 110.

The jig body 110 has a substantially thin plate-shaped component and may provide a space and/or mount (or a seat) for mounting the measurement object 200. The jig body 110 includes a plurality of protrusions 114 serving as a mount. The protrusions 114 may be integrally formed with the jig body 110, and may be formed to be parallel to the upper surface (or lower surface) of the jig body 110.

A through hole 101 is formed in the center of the jig body 110. The through hole 101 may be prepared to pass through the jig body 110 to transmit the light from the light source 15 of FIG. 1. The through hole 101 may be formed to be substantially larger than the measurement object (e.g., the measurement object 200 of FIG. 1).

The through hole 101 may vary in size. Further, although the through hole 101 illustrated in FIG. 2 has a substantially rectangular shape, the disclosure is not limited to this shape.

The protrusion 114 may have a shape protruding from the inner surface of the jig body 110 toward the through hole 101.

The measuring jig 100 of the disclosure may include a plurality of protrusions 114. The plurality of protrusions 114 protrude from the inner surface of the jig body 110 toward the through-hole 101, preventing an object (e.g., a measurement object) placed on the through hole 101 from falling through. Although FIG. 2 illustrates two protrusions 114 protruding from one inner surface of the jig body 110 and two other protrusions 114 protruding from the opposite inner surface of the jig body 110, with the through hole 101 disposed therebetween, the disclosure is not limited thereto. Since the protrusions 114 protrude towards the through hole 101, a measurement object (e.g., the measurement object 200 of FIG. 1) may be mounted on the through hole 101, even when the through hole 101 is larger than the measurement object.

According to various embodiments, the measuring jig 100 may be seated and used on the base jig 12. The measuring jig 100 may be seated on the base jig 12 as two opposite ends of the jig body 110 are fitted into the base jig 12. The base jig 12 may be placed on the platform 11 and have a base opening 12′ in a position corresponding to the through hole 101 of the jig body 110. Accordingly, light emitted from a light source (e.g., the light source 15 of FIG. 1) may be transmitted through the base opening 12′ and the through hole 101 and then the measurement object (e.g., the measurement object 200 of FIG. 1) and to the optical module (e.g., the optical module 21 of FIG. 21).

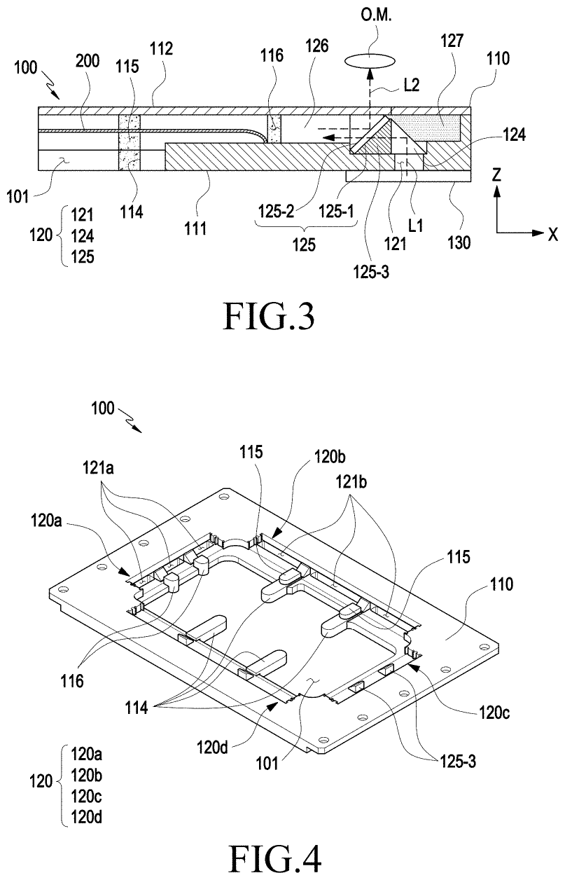

A lighting unit 130 is provided on one surface (e.g., a first surface (or lower surface)) of the jig body 110. The lighting unit 130 may have a shape corresponding to the rest of the jig body 110 except for the opening 101. The lighting unit 130 may emit light in a direction (e.g., a direction parallel with the Z axis of FIG. 3), in addition to the light source (e.g., the light source 15 of FIG. 1).

The jig body 110 also includes a light guide including components (e.g., 124a, 124b, 125a, 125b, 127a, 127b, 127c, and 127d) for guiding light un different directions.

FIG. 3 is a cross-sectional view illustrating a measuring jig according to an embodiment.

Referring to FIG. 3, the measuring jig 100 includes a light guide 120. The light guide 120 guides light provided from one surface (e.g., a first surface 111) of the jig body 110 to the opposite surface (e.g., a second surface 112) of the jig body 110.

Referring to FIGS. 2 and 3, the light guide 120 may be integrally formed with the jig body 110 and be disposed to surround the through hole 101. The light guide 120 may guide the light incident onto one side of the jig body 110 to the other side of the jig body 110, and may include a different opening (e.g., the opening 121) from the through hole 101 formed through the jig body 110.

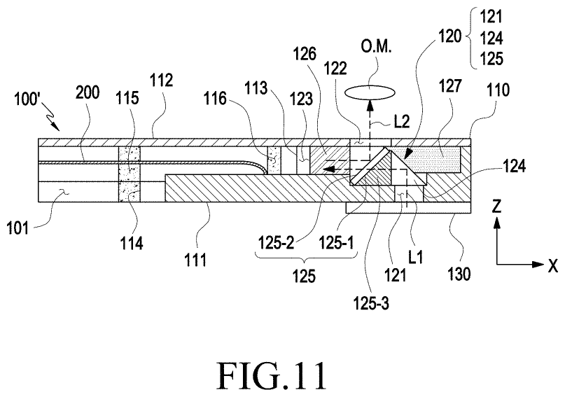

The jig body 110 includes a first surface 111 and a second surface 112 that faces away from the first surface 111. The first surface 111 may face a direction in which it is seated on the platform (e.g., the platform 11 of FIG. 11) or the base jig (e.g., the base jig 12 of FIG. 1), and the second surface 112 may face a direction parallel to the traveling direction of light emitted from the light source (e.g., the light source 15 of FIG. 1) (or a surface facing away from the first surface).

The opening 121 may be formed in the first surface 111 of the jig body 110. The opening 121 may be formed in a different position from the through hole 101 formed in the center of the jig body 110. Alternatively, the opening 121 may be formed in the outlying portion of the jig body 110, unlike the through hole 101 formed in the center of the jig body 110.

The lighting unit 130 may be disposed adjacent to the first surface 111 of the jig body 110. An adhesive member may be provided on the first surface 111 of the jig body 110 or one surface of the lighting unit 130 to adhere the jig body 110 and the lighting unit 130 to each other. The lighting unit 130 may be provided to correspond to a position where the opening 121 is formed, and may emit light toward the opening 121.

The light guide 120 includes a first light path changing member 124 and a second light path changing member 125. The first light path changing member 124 changes the traveling path of light provided from the lighting unit 130 and incident through the opening 121. The second light path changing member 125 transmits light incident from one direction and provided from the lighting unit 130 and changes the traveling path of the light incident from another direction. The light incident from the one direction to the second light path changing member 125 may be the light transmitted through the first light path changing member 124.

The first light path changing member 124 and the second light path changing member 125 may be sequentially arranged along the traveling path of the light incident through the opening 121. Here, the “traveling path of light” may include a path along which the light first provided from the lighting unit 130 first passes through the opening 121 to the first light path changing member 124 and the second light path changing member 125.

The first light path changing member 124 may change the traveling direction of light to allow the light incident onto the opening 121 to refract to a predetermined angle and travel. For example, the first light path changing member 124 may be a triangular prism having a pair of orthogonal surfaces and an inclined surface. The first light path changing member 124 is formed adjacent to the opening 121 and may be disposed so that one of the pair of orthogonal surfaces abuts the opening 121. The other of the pair of orthogonal surfaces may be disposed to face the center of the jig body 110. In this case, the inclined surface may be disposed to face the outside of the jig body 110. For example, the inclined surface may be formed to face a direction inclined at 45 degrees from the first surface 11 of the jig body 110. When the measurement object 200 is placed on the measuring jig 100, the first light path changing member 124 may refract, on the inclined surface, the light incident through the opening 121 formed in the first surface 11 of the jig body 110 to a side surface of the measurement object 200.

The second light path changing member 125 may be formed adjacent to the first light path changing member 124 to transmit or refract the light transmitted through the first light path changing member 124. The light first refracted by the first light path changing member 124 may be directed through the second light path changing member 125 to the measurement object. The second light path changing member 125 may transmit the light that has been refracted by the first light path changing member 124 and incident in one direction (e.g., the direction opposite to the X-axis direction of FIG. 3) and reflect (e.g., refract and reflect) the light incident in another direction (e.g., the direction parallel to the X axis of FIG. 3), thereby changing the traveling path of light. For example, the second light path changing member 125 may be a semi-transparent mirror that partially reflects and partially transmits light. The second light path changing member 125 may be formed of a thin flat mirror. The second light path changing member 125 may be formed to transmit the light incident onto one surface 125-1 and reflect the light incident onto another surface 125-2. The second light path changing member 125 is formed adjacent to the first light path changing member 124, with one surface of the second light path changing member 125 inclined from the first surface 111 of the jig body 110. The other surface 125-2 of the second light path changing member 125 may be formed to face in a direction substantially perpendicular to the inclined surface of the first light path changing member 124. Accordingly, the other surface 125-2 of the second light path changing member 125 may also be formed to face in a direction 45-degree inclined from the first surface 111 of the jig body 110.

The measuring jig 100 furthers include a support member 125-3 for placing the second light path changing member 125 to be inclined from the first surface 111 of the jig body 110. The support member 125-3 may be shaped as a triangular prism having one pair of orthogonal surfaces and an inclined surface, and one of the pair of orthogonal surfaces of the support member 125-3 may be disposed to face one surface of the pair of orthogonal surfaces of the first light path changing member 125. One of the pair of orthogonal surfaces of the support member 125-3 may face and contact one surface of the pair of orthogonal surfaces of the first light path changing member 125. The measuring jig 100 may include a plurality of support members 125-3 in predetermined positions around the through hole 101.

The measuring jig 100 further includes a cover 127 to prevent the light L1 incident to the first light path changing member 124 from leaking to the outside of the jig body 110. The cover 127 may be disposed on the second surface 112 of the jig body 110, preventing the light L1 incident through the opening 121 from passing through the first light path changing member 124 or the jig body 110 to the outside. The cover 127 may be disposed adjacent to the first light path changing member 124 and may have at least one inclined surface to face the inclined surface of the first light path changing member 124.

The light guide 120 may be designed to allow the light refracted by the first light path changing member 124 to pass through the second light path changing member 125 to the side surface of the measurement object 200. The light guide 120 may guide the incident light L1 from the lighting unit 130 to sequentially pass through the opening 121 of the jig body 110, the first light path changing member 124, and the second light path changing member 125 and guide the outgoing light L2 in a direction parallel to the direction in which the second surface 112 of the jig body 110 faces. The outgoing light L2 emitted to the outside of the jig body 110 may arrive at the optical module of the optical tower unit, allowing the measuring device to obtain an image of the measurement object 200.

The measuring jig 100 further includes side support members 115 and 116 for fixing the position of the measurement object 200.

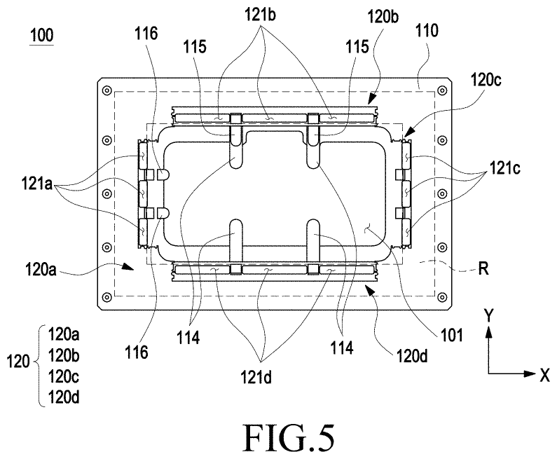

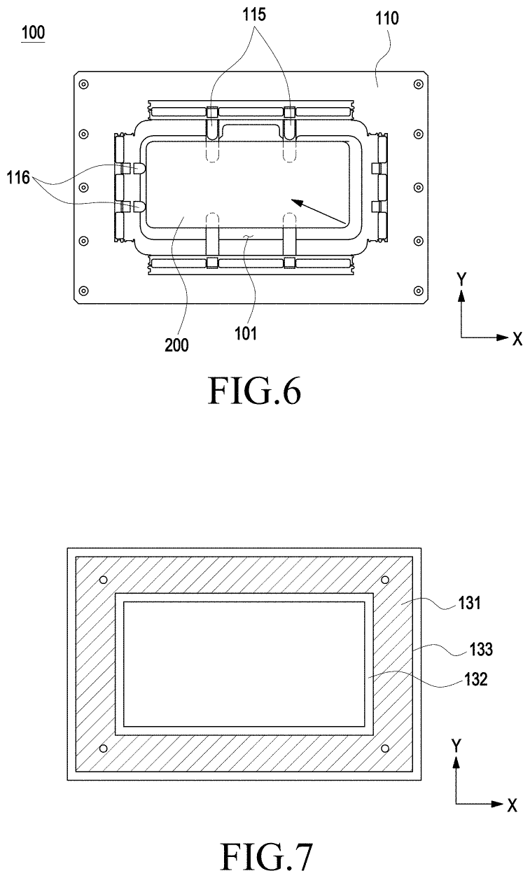

FIG. 4 illustrates a partial configuration of a measuring jig according to an embodiment. FIG. 5 illustrates a partial configuration of a measuring jig according to an embodiment. FIG. 6 illustrates an example in which a measurement object is measured using a measuring jig according to an embodiment.

Referring to FIGS. 4, 5, and 6, the measuring jig 100 includes a plurality of light guides 120a, 120b, 120c, and 120d.

More specifically, the measuring jig 100 includes a first light guide 120a formed along one side of the periphery of the through hole 101 and a second light guide 120b formed along another side of the periphery of the through hole 101. The second light guide 120b may be formed adjacent to the first light guide 120a. For example, if the first light guide 120a is formed along one side (e.g., a vertical side) of the through hole 101 having a substantially rectangular shape, the second light guide 120b may be formed along another side (e.g., a horizontal side) of the through hole 101 adjacent to the one side.

Alternatively, the measuring jig 100 may include the first light guide 120a formed along one side of the periphery of the through hole 101 and a third light guide 120c formed on another side of the through hole 101, opposite to the first light guide 120a. The third light guide 120c may be disposed on the opposite side from the first light guide 120a to face the first light guide 120a. For example, if the first light guide 120a is formed along one side (e.g., a vertical side) of the through hole 101 having a substantially rectangular shape, the third light guide 120c may be formed along another side (e.g., a vertical side) which is opposite to the one side of the through hole 101.

Alternatively, the measuring jig 100 may include light guides arranged in three different areas around the through hole 101 or light guides arranged in four different areas around the through hole 101. For example, the light guide 120 may include the first light guide 120a, the second light guide 120b, the third light guide 120c, and a fourth light guide 120d disposed at four different corners of the through hole 101 when the through hole 101 has a substantially rectangular shape. Here, the first light guide 120a may be disposed in a position facing the third light guide 120c, and the second light guide 120b may be disposed in a position facing the fourth light guide 120d.

The measuring jig 100 in FIGS. 4 and 5 is similar to that in FIG. 3, except for the first light path changing member (e.g., the first light path changing member 124 of FIG. 3), the second light path changing member (e.g., the second light path changing member 125 of FIG. 3), and the cover (e.g., the cover 127 of FIG. 3) constituting the light guide (e.g., the light guide 120 of FIG. 3). The positions of the light guides 120a, 120b, 120c, and 120d may be schematically shown through the openings 121a, 121b, 121c, and 121d included in the light guides 120a, 120b, 120c, and 120d.

When a lighting unit (e.g., the lighting unit 130 of FIG. 2) is disposed on the lower surfaces of the openings 121a, 121b, 121c, and 121d to provide light, light may pass through the jig body 110 through the openings 121a, 121b, 121c, and 121d as illustrated in FIGS. 4 and 5. However, the measuring jig 100 may also be designed so that light is refracted to the measurement object 200, rather than directly passing through the measurement object 200 via the openings 121a, 121b, 121c, and 121d. In the measuring jig 100, the light provided through the lighting unit (e.g., the lighting unit 130 of FIG. 2) may be guided to the side surface of the measurement object 200 through other components (e.g., the first light path changing member 124, the second light path changing member 125, and the cover 127 of FIG. 3) of the light guide 120.

The measuring jig 100 further includes side support members 115 and 116 for fixing the position of the measurement object 200 when mounted therein. A plurality of side support members 115 and 116 may be disposed around the through hole 101.

Referring to FIG. 6, the plurality of side support members 115 and 116 are disposed on at least two side surfaces of the through hole 101. That is, a plurality of first side support members 115 are disposed on one side (e.g., a horizontal side) around the through hole 101, and a plurality of second side support members 116 are disposed on another side (e.g., a vertical side) adjacent to the one side around the through hole 101. For example, as illustrated in FIGS. 4 and 5, two first side support members 115 may be disposed on a horizontal side around the through hole 101, and two second side support members 116 may be disposed on a vertical side around the through hole 101.

As another example, the plurality of first side support members 115 may be disposed on the protrusions 114 protruding from the jig body 110 toward the through hole 101. Here, the plurality of first side support members 115 may protrude vertically from the protrusions 114 protruding from the jig body 110 toward the through hole 101 to have a stepped shape.

As illustrated in FIG. 6 is a conceptual view illustrating an example of measuring a measurement object 200 using a measuring jig 100. First, the measurement object 200 is mounted on the measuring jig 100, and may then be brought in tight contact to a side. For example, after mounted on the protrusions 114, the measurement object 200 may be pushed in a diagonal direction so that the side surfaces of the measurement object 200 are supported by the first side support members 115 and the second side support members 116. When the measurement object 200 comes in tight contact with the first side support members 115 and the second side support members 116 so that its position is fixed, an image of the measurement object 200 may be obtained through a measuring device (e.g., the measuring device 10 of FIG. 1). Thus, it is possible to reduce errors in a dimension inspection process.

FIG. 7 illustrates a lighting unit according to an embodiment.

Referring to FIG. 7, the lighting unit includes a light source emitting surface 131 and edge portions 132 and 133 surrounding the light source emitting surface 131. The lighting unit may have an opening, corresponding to the through hole (e.g., the opening 101 of FIG. 6) of the jig body (e.g., the jig body 110 of FIG. 6), in the center thereof. The lighting unit may have a closed loop curve as illustrated in FIG. 7.

The light emitted from the lighting unit 130 may be turned on/off and adjusted for brightness by a power unit (not shown) and/or a controller (not shown) electrically connected with the lighting unit 130. The lighting unit may include various light sources, such as a light emitting diode (LED), an organic LED (OLED), and a liquid crystal display (LCD) may correspond to the lighting unit 130.

Referring to FIGS. 5 and 7, the light source emitting surface 131 of the lighting unit 130 may have a size corresponding to a region R formed in the jig body 110. The region R is a region including all the portions in which the openings 121 are formed in the jig body 110, and accordingly, the lighting unit 130 may provide a light source to all of the plurality of openings 121 formed in a plurality of positions of the jig body 110. Accordingly, it is possible to uniformly provide light to all of the plurality of openings 121 formed in a plurality of positions of the jig body 110 through the lighting unit 130, thereby obtaining a uniform 2D image for the measurement object (e.g., the measurement object 200 of FIG. 6) through the optical module (e.g., the optical module 21 of FIG. 1).

Light provided from the lighting unit may be the same or a different type of light as the light provided from the light source (e.g., the light source 15 of FIG. 1). For example, since the light source may be disposed inside the platform (e.g., the platform 11 of FIG. 1), it may be relatively far from the measuring jig 100. Thus, since the focal depth should be long (or deep), high power may be required when emitting light. However, as the lighting unit in FIG. 7 may be disposed adjacent to the measuring jig 100, the focal depth is relatively shorter than the focal depth of the light emitted from the light source (e.g., the light source 15 in FIG. 1). That is, since light emitted from the lighting unit 130 may have a significantly short focal depth as compared to the light emitted from the light source (e.g., the light source 15 of FIG. 1), the lighting unit 130 may output light in relatively low power. The light emitted from the lighting unit 130 may be selected to be able to obtain a clear image while its output power is relatively lower than the light emitted from the light source (e.g., the light source 15 of FIG. 1). For example, the light source (e.g., the light source 15 of FIG. 1) may provide telecentric light, and the lighting unit (e.g., the lighting unit 130 of FIG. 1) may provide OLED light.

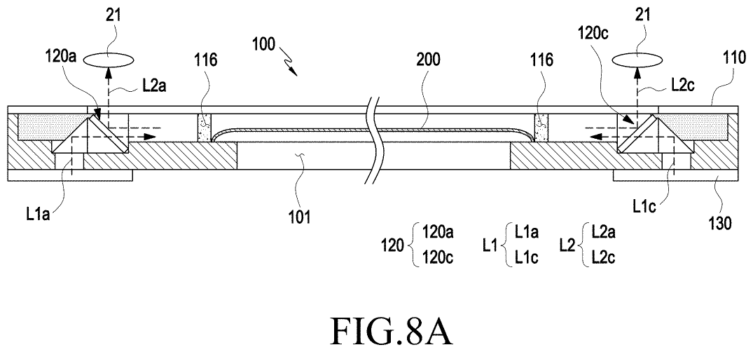

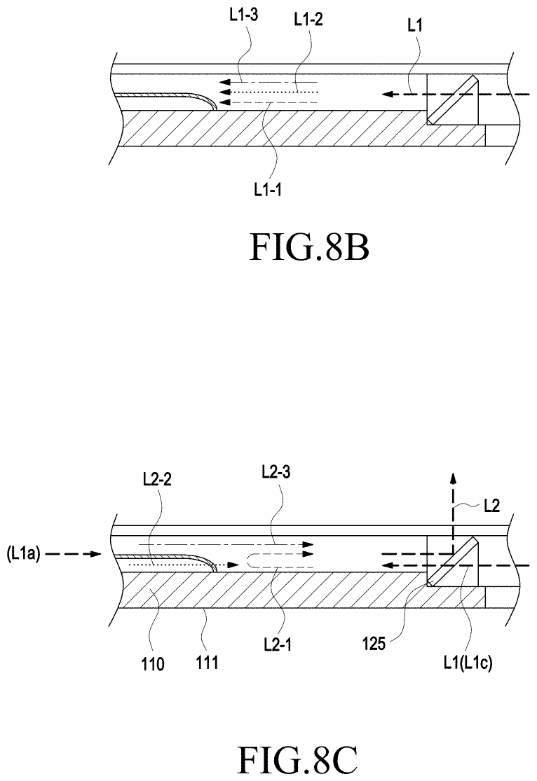

FIG. 8A is a cross-sectional view illustrating a measuring jig according to an embodiment. Specifically, FIG. 8A illustrates a lengthwise cross section of the measuring jig 100 unlike the partial cross section illustrated in FIG. 3.

Referring to FIG. 8A, the measuring jig 100 includes light guides 120a and 120c inside the jig body 110. The light guides 120a and 120c may be formed to face each other in opposite directions.

Lighting units 130 may individually provide light to different openings (e.g., the openings 121a and 121c of FIG. 5) included in two different light guides (e.g., a first light guide 120a and a third light guide 120c). The first light guide 120a may guide the incident light L1a incident from the lighting unit 130 to sequentially pass through the opening of the jig body 110, the first light path changing member, and the second light path changing member and guide the outgoing light L2a to exit in a direction parallel to the direction in which the second surface of the jig body 110 is directed and to reach the optical module (e.g., the optical module 21 of FIG. 1). The third light guide 120c may guide the incident light L1c incident from the lighting unit 130 to sequentially pass through the opening of the jig body 110, the first light path changing member, and the second light path changing member and guide the outgoing light L2c to exit in a direction parallel to the direction in which the second surface of the jig body 110 is directed and to reach the optical module (e.g., the optical module 21 of FIG. 1). The incident light L1a and 11c incident from the lighting unit 130 move toward the center of the jig body 110 (first direction), and the outgoing light L2a and L2c move away from the center of the jig body 110 (second direction) and are then refracted by the second light path changing member to the outside.

FIG. 8B illustrates light beams traveling in a first direction (or centripetal direction) inside a measuring jig according to an embodiment. FIG. illustrates light beams traveling in a second direction (or centrifugal direction) inside a measuring jig according to an embodiment.

Referring to FIGS. 8A and 8B, the incident light L1 incident on the light guide 120 first changes its direction (e.g., refracts) while passing through the first light path changing member (e.g., the first light path changing member 124 of FIG. 3) and then passes through the second light path changing member (e.g., the second light path changing member 125 of FIG. 3) and then travels in a first direction (or centripetal direction) towards the measurement object. After first being refracted by the first light path changing member and then transmitted through the second light path changing member, the incident light L1 may be divided into light L1-1 reaching and reflected by the measurement object, light L1-2 passing through the measurement object, and light L1-3 passing through the surroundings, but not the measurement object 200, as illustrated in FIG. 8B. For example, part of the incident light L1c incident on the third light guide 120c is reflected by the measurement object back to the third light guide 120c, another part thereof passes through the measurement object 200 to the first light guide 120a, and the other part thereof may be directed to the first light guide 120a without passing through the measurement object.

Referring to FIGS. 8A and 8C, the outgoing light L2 exiting from the light guide 120 may be directed in a second direction (centrifugal direction) inside the measuring jig and is refracted by the second light path changing member to the outside of the measuring jig.

As illustrated in FIG. 8C, the outgoing light L2 coming out of the third light guide 120c may include light L2-1 incident on the third light guide 120c and then reflected by the measurement object, light L2-2 incident on the first light guide 120a and passing through the measurement object to the third light guide 120c, and light L2-3 incident on the first light guide 120a and then passing through the surroundings of the measurement object 200, but not the measurement object 200, to the third light guide 120c.

The measuring jig 100 may obtain a clear image for the measurement object 200 using a plurality of light guides, e.g., the first light guide 120a and the third light guide 120c, disposed opposite each other with respect to the through hole 101.

In relation to the relative strength of the outgoing light L2 reaching the second light path changing member, the light transmitted through the surroundings of the measurement object, but not the measurement object, of the outgoing light L2 may have a larger quantity than the light reflected by the measurement object and the light transmitted through the measurement object. Since the light reflected by the measurement object and the light transmitted through the measurement object are less than the light that does not pass through the measurement object, the image of the measurement object may have a shadow through which the dimensions of the measurement object may be measured.

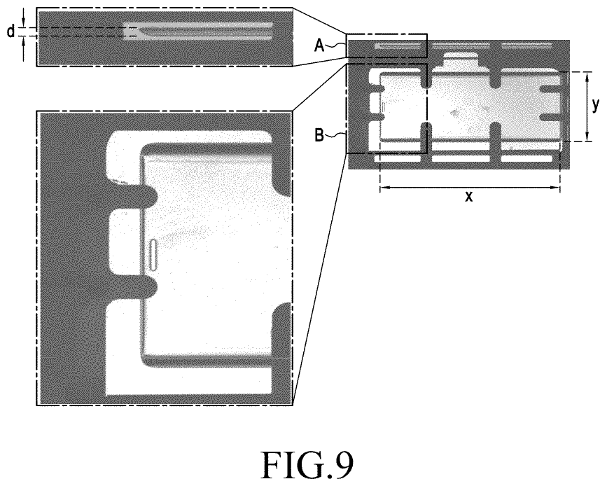

FIG. 9 illustrates a 2D image obtained by capturing a measurement object using a measuring device according to an embodiment.

Referring to FIG. 9, a 2D image of a measurement object (e.g., the measurement object 200 of FIG. 1) may be obtained using a measuring device (e.g., the measuring device 10 of FIG. 1).

The 2D image may be obtained using the measuring jig 100 having the second light guide 120b and the fourth light guide 120d as illustrated in FIG. 5. The 2D image may be obtained only for one of the plurality of side surfaces of the measurement object as the lighting unit (e.g., the lighting unit 130 of FIG. 2) selectively provides light only to the second light guide 120b.

A plan image B of the measurement object and a side image A thereof may be obtained using an optical module (e.g., the optical module 21 of FIG. 1) included in the measuring device.

The 2D image obtained through the optical module (e.g., the optical module 21 of FIG. 1) may be displayed on the monitor unit (e.g., the monitor unit 30 of FIG. 1). In the 2D image displayed on the monitor unit, the plan image B of the measurement object and the side image A of the measurement object both may be displayed. A worker may inspect the plan dimensions (e.g., horizontal length x and vertical length y) of the measurement object from the plan image and inspect the side dimension (e.g., thickness d) of the measurement object from the side image A. Thus, the inspector may simultaneously identify the plan and side dimensions of the measurement object, thereby quickly completing the inspection.

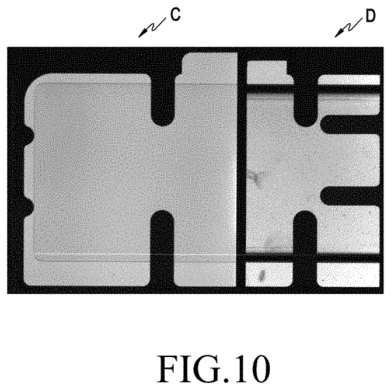

FIG. 10 illustrates a 2D image obtained by capturing a measurement object using a measuring device according to an embodiment. Specifically, FIG. 10 illustrates 2D images with different qualities, as obtained through an optical module.

Referring to FIG. 10, image D on the right is an image obtained using telecentric lighting, and image C on the left is an image obtained using OLED lighting.

As illustrated in FIG. 10, image C obtained using OLED lighting has a higher resolution and sharpness than image D obtained using telecentric lighting.

The measuring device (e.g., the measuring device 10 of FIG. 1) may obtain a clearer image using OLED lighting, as well as telecentric lighting, thus more precisely measuring the dimensions of the measurement object.

FIG. 11 illustrates a measuring jig according to an embodiment. Since most of the components in FIG. 11 have already been described above with reference to FIG. 3, no further description is given of the same components below.

Referring to FIG. 11, the measuring jig 100′ includes a jig body 110 for mounting the measurement object 200 and a lighting unit 130 disposed adjacent to one surface of the jig body 110.

The jig body 110 of the measuring jig 100′ includes a through hole 101, at least one protrusion 114 protruding toward the through hole 101, and a light guide 120 disposed to surround at least a portion of the through hole 101. The lighting unit 130 may be disposed adjacent to the first surface 111 of the jig body 110.

The light guide 120 includes an opening 121 formed in the first surface 111 of the jig body 110 and where the light provided from the lighting unit is incident and may further include a third opening 122 formed in the second surface 112, which faces away from the first surface 11, and from which at least one light beam L2 among light beams reflected from the measurement object 200 comes out. The light guide 120 further includes a first light path changing member 124 disposed on the traveling path of light between the opening 121 and the third opening 122 and refracting the light L1 incident through the opening 121 to the side surface of the measurement object 200, and a second light path changing member 125 disposed behind the first light path changing member 124 along the traveling direction of the light L1 incident through the opening 121 and refracting at least one light beam of the light beams reflected from the measurement object to the third opening 122.

The light guide 120 furthers include a fourth opening 123 formed in an inner surface 113 of the jig body 110 between the first surface 111 and second surface 112 of the jig body 110, and further includes a light path extension 126 formed between the second light path changing member 125 and the fourth opening 123.

Light incident to the side surface of the measurement object 200 may exit through the fourth opening 123, or light transmitted through or reflected by the measurement object 200 may be incident. The light path extension 126 may provide a light traveling path when the light transmitted through the second light path changing member 125 reaches the fourth opening or when the light transmitted through or reflected by the measurement object 200 reaches the second light path changing member 125, thereby allowing an optical module (e.g., the optical module 21 of FIG. 1) to obtain a clearer image. The sharpness of the image forming on the optical module (e.g., the optical module 21 of FIG. 1) may be adjusted by adjusting the length of the light path extension 126. Using the light path extension 126, the light reaching the measurement object 200 may be concentrated.

As set forth above, a measuring jig and a measuring device including the measuring jig may simply place a measurement object firmly in position regardless of the size of the measurement object, thereby allowing for quick and convenient measurement. The measuring jig and the measuring device may simultaneously measure the plan image and side image of a 3D measurement object, thereby allowing quick and precise measurement of the measurement object.

According to an embodiment, a measuring device may further include a mount for mounting a measurement object. For example, the mount may be a component that is provided in addition to, or instead of, at least one protrusion (e.g., the protrusion 114 of FIG. 2) as described above.

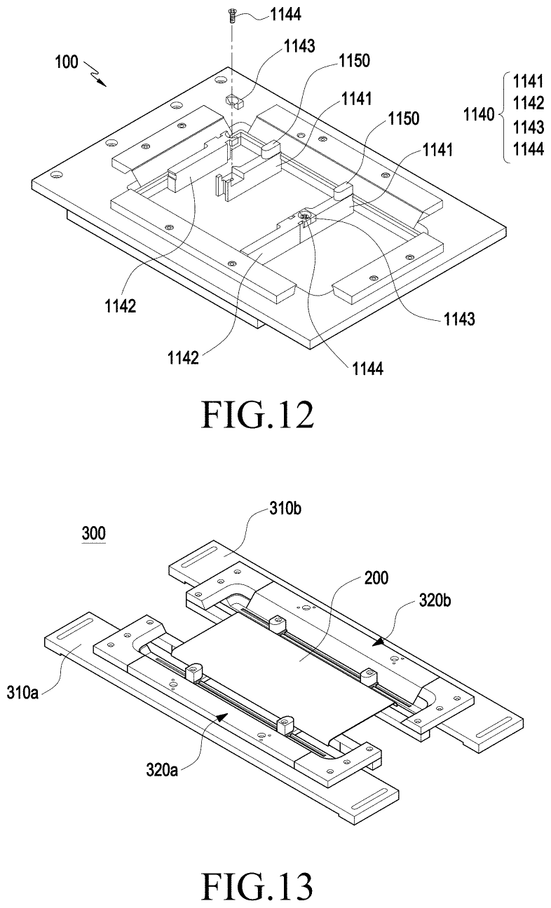

FIG. 12 illustrates a mount according to an embodiment.

Referring to FIG. 12, a mount 1140 is disposed in the opening (e.g., the opening 101 of FIG. 2), and may have an end in tight contact with an inner surface of the jig body (e.g., the jig body 110 of FIG. 2) and another end in tight contact with another inner surface of the jig body.

More specifically, the mount 1140 includes a first mount part 1141 and a second mount part 1142 formed so that their respective ends are coupled together. The respective first ends of the first mount part 1141 and the second mount part 1142 may be coupled together while the respective second ends thereof are coupled to the inner surfaces of the jig body.

The mount 1140 further includes a tightening block 1143 and a tightener 1144 (e.g., a screw). The tightening block 1143 may be fitted into a space formed by the first mount part 1141 and the second mount part 1142. The tightener 1144 may contact at least a portion of the first mount part 1141 and the second mount part 1142 and the fastening block 1143 and, while fastened, allows the fastening block 1143 to push the first mount part 1141 or the second mount part 1142 so that the mount 1140 may maintain a predetermined tension in the opening.

A side support member 1150 is provided on the top of a side of the mount 1140, in addition to, or instead of, the above-described side support member (e.g., the side support member 115 of FIG. 3). According to an embodiment, different types of measuring jigs may be provided.

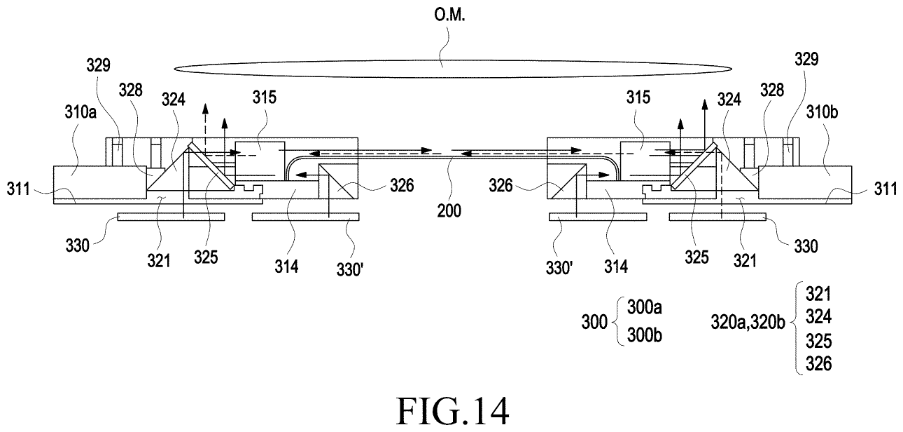

FIG. 13 illustrates a measuring jig according to an embodiment. FIG. 14 is a cross-sectional view illustrating a measuring jig according to an embodiment.

Referring to FIG. 13, a measuring jig 300 includes a first jig body 310a and a second jig body 310b.

The first jig body 310a includes a first light guide 320a. For example, when the measurement object 200 has a rectangular shape as viewed from above, the first jig body 310a may directly or indirectly support one side surface of the measurement object 200. The second jig body 310b includes a second light guide 320b. For example, when the measurement object 200 has a rectangular shape as viewed from above, the second jig body 310b may directly or indirectly support another side surface of the measurement object. The second jig body 310b may support the measurement object 200 on the opposite side of the first jig body 310a when the measurement object 200 is placed on the measuring jig 300. Here, the term “rectangular shape” may refer to a polygon composed of four line segments, but the vertexes formed by the four line segments are not necessarily right angles but may rather be curved. Similarly, the measurement object 200 of the disclosure is not limited to a rectangular shape but may have a different shape, such as a triangle.

A lighting unit 330 is provided on one surface (e.g., a first surface (or lower surface)) of each of the jig body 310a and 310b. The lighting unit 330 may emit light, in addition to the from a light source (e.g., the light source 15 of FIG. 1).

Although FIG. 14 illustrates two separate lighting units 310 provided corresponding to the first jig body 310a and the second jig body 310b, the lighting unit 130 may instead be shaped as a rectangle having a through hole in the center thereof.

In FIGS. 13 and 14, the first light guide 320a and the second light guide 320b are disposed to face each other on two opposite sides of the measurement object 200 when the measurement object is mounted on the jig body 310a and 310b. The first light guide 320a and the second light guide 320b include openings 321 (e.g., the opening 121 of FIG. 3) formed in their respective surfaces (e.g., the first surface (or lower surface)). In FIG. 13, the opening 321 is different from the through hole 101 of FIG. 3.

The first light guide 320a and the second light guide 320b are provided from the lighting unit 330 and include a first light path changing member 324 to change the traveling path of the light incident through the opening 321. The first light guide 320a includes a second light path changing member 325 to transmit the light provided from the lighting unit 330 and incident in one direction and change the traveling path of the light incident in another direction. The light incident from the one direction to the second light path changing member 325 may be the light transmitted through the first light path changing member 324. The first light path changing member 324 and the second light path changing member 325 may be sequentially arranged along the traveling path of the light incident through the opening 321.

The first light path changing member 324 may change the traveling direction of light to allow the light incident onto the opening 321 to refract to a predetermined angle and travel. For example, the first light path changing member 324 may be a triangular prism having a pair of orthogonal surfaces and an inclined surface. The first light path changing member 324 is formed adjacent to the opening 321 and may be disposed so that one of the pair of orthogonal surfaces abuts the opening 321. The other of the pair of orthogonal surfaces may be disposed to face the center of the jig body 310a or 310b. In this case, the inclined surface may be disposed to face the outside of the jig body 310a or 310b. The inclined surface may be formed to face in a direction inclined at 45 degrees from the first surface 311 of the first jig body 310a. When the measurement object 200 is placed on the measuring jig 300, the first light path changing member 324 may refract, on the inclined surface, the light incident through the opening 321 formed in the first surface 311 of the jig body 310a and/or 310b to a side surface of the measurement object 200.

The second light path changing member 325 may be formed adjacent to the first light path changing member 324 to transmit or refract the light transmitted through the first light path changing member 324. The light first refracted by the first light path changing member 324 may be directed through the second light path changing member 325 to the measurement object 200. The second light path changing member 325 may transmit the light that has been refracted by the first light path changing member 324 and incident in one direction, and reflect (e.g., refract and reflect) the light incident in another direction. For example, the second light path changing member 325 may be a semi-transparent mirror that partially reflects and partially transmits light. The second light path changing member 325 may be formed of a thin mirror. In this case, the second light path changing member 125 may be formed to transmit the light incident onto one surface and reflect the light incident onto another surface. The second light path changing member 325 is formed adjacent to the first light path changing member 324, with one surface of the second light path changing member 325 inclined from the first surface 311 of the jig body 310. The other surface of the second light path changing member 325 may be formed to face in a direction substantially perpendicular to the inclined surface of the first light path changing member 324. Accordingly, the other surface of the second light path changing member 325 may also be formed to face in a direction 45-degree inclined from the first surface 311 of the jig body 310a and/or 310b.

The first light guide 320a and the second light guide 320b further include a third light path changing member 326, in addition to the first light path changing member 324 and the second light path changing member 325, as light path changing members. The third light path changing member 326 may be disposed inside the measurement object 200, unlike the first light path changing member 324 and the second light path changing member 325 disposed outside the measurement object 200 when the measurement object 200 is mounted.

The third light path changing member 326 may change the traveling direction of light to allow the light provided from a lighting unit 330′ to refract to a predetermined angle and travel. For example, the third light path changing member 326 may be a triangular prism having a pair of orthogonal surfaces and an inclined surface. The first light path changing member 314 and the third light path changing member 326 may be configured as prisms having the same shape and/or specifications.

The lighting unit 330′ (hereinafter, the lighting unit 330 is referred to as a first lighting unit 330 and the lighting unit 330′ is referred to as a second lighting unit 330′) may be disposed under the third light path changing member 326. The light provided from the second lighting unit 330′ may be refracted by the third light path changing member 326 to be oriented from inside of the measurement object 200 to the second light path changing member 325. Here, the second lighting unit 330′ may be the same light source as the first lighting unit 330 providing light to the opening 321 or may be a light source separately provided therefrom. For example, the first lighting unit 330 and the second lighting unit 330′ may be formed of a single light source. Alternatively, the first lighting unit 330 and the second lighting unit 330′ may be light sources that are separated from each other and independently driven.

Each of the first jig body 310a and the second jig body 310b includes at least one protrusion 314, which plays a role as a mount for the measurement object, and a side support member 315 to restrict horizontal movement of the measurement object. The third light path changing member 326 may connect to the at least one protrusion 314. The at least one protrusion 314 may have a shape protruding a predetermined length from each of the first jig body 310a and the second jig body 310b, and one end thereof may be fixedly connected to the third optical path changing member 326.

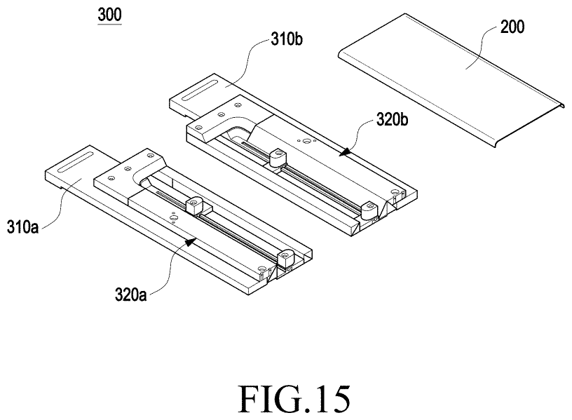

FIG. 15 illustrates a portion of a measuring jig that is cut away according to an embodiment.

Referring to FIG. 15, when a measurement object 200 is not positioned on the first jig body 310a and the second jig body 310b, the first jig body 310a and the second jig body 310b may be installed in a measuring device, spaced apart from each other. Although not illustrated in FIG. 15, the measuring jig 300 may include a lighting unit 330 and/or 330′ disposed on the rear surfaces of the first jig body 310a and the second jig body 310b.

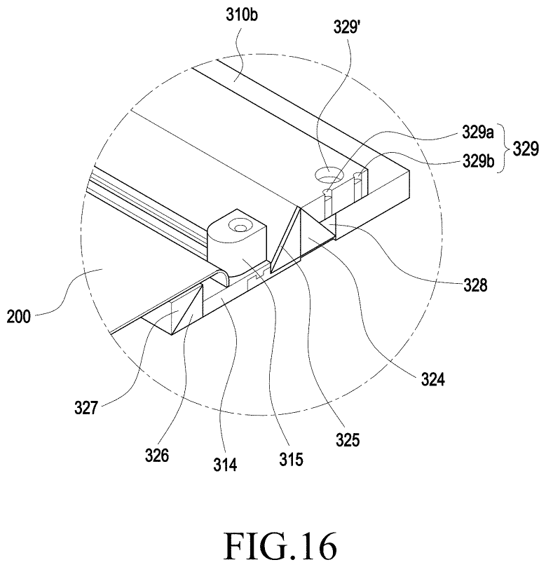

FIG. 16 illustrates an enlarged view of a portion of the measuring jig of FIG. 15. Referring to FIG. 16, the measuring jig 300 includes a cover 327 to prevent the light incident to the third light path changing member 326 from traveling in a direction other than a predesignated direction. The cover 327 may be disposed adjacent to the third light path changing member 326 and may have at least one inclined surface to face the inclined surface of the third light path changing member 326.

The second light path changing member 325 may transmit the light provided from the first lighting unit 330 incident in one direction while changing the traveling path of the light incident in another direction. Further, the second light path changing member 325 may include at least one of the light refracted by the measurement object, the light reflected by the measurement object, and the light transmitted through the surroundings of the measurement object, as light incident from the other direction to the second light path changing member 325. The light incident from the other direction to the second light path changing member 325 may further include the light provided from the second lighting unit 330′ and refracted by the third light path changing member 326.

The measuring jig 300 further includes the third light path changing member 325 and may obtain an image of the measurement object 200 using the third light path changing member 326, more accurately measuring an area in which no light is transmitted inside the measurement object 200, e.g., a black layer-printed 3D glass.

FIG. 17 illustrates a slidable side support member according to an embodiment.

Referring to FIG. 17, a measuring jig includes at least one side support member 315 to restrict movement of a measurement object when the measurement object is mounted. The side support member 315 may slide along the length direction of the second light path changing member 325. For example, the side support member 315 may be configured as a block couplable with a jig body 310a and/or 310b as illustrated in FIGS. 16 and 17. In this case, the jig body 310a and/or 310b may have a groove 315′ to allow the side support member 315 to slide. As the side support member 315 is configured to be slidable along the length direction of the second light path changing member 325, the position of the side support member may be adjusted to fit the size and specifications of the measurement object, thus allowing for more accurate measurement.

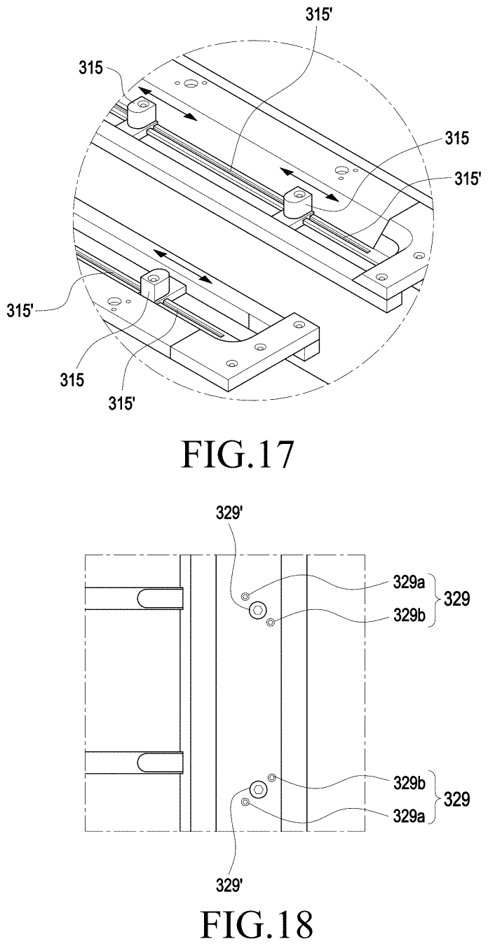

FIG. 18 illustrates a position adjuster of a measuring jig according to an embodiment.

Referring to FIG. 18, the measuring jig includes at least one position adjuster 329. For example, the position adjuster 329 may be a threaded bolt. The position adjuster 329 may be a component distinguished from the fastener 329′ for fastening the jig body 310a and/or 310b of the measuring jig 300 with the light guide 320a and/or 320b, and the position adjuster 329 may be used as a fastener and to adjust the position of the first light path changing member 324 as described below.

The position adjuster 329 may be disposed on the upper surface of the jig body 310a and/or 310b. There may be provided at least two or more position adjusters 329. For example, a first position adjuster 329a may be provided on the upper surface of the jig body 310a and/or 310b, and a second position adjuster 329b may be provided behind the first position adjuster 329a and spaced apart from the first position adjuster 329a by a predetermined distance (in the opposite direction from the measurement object).

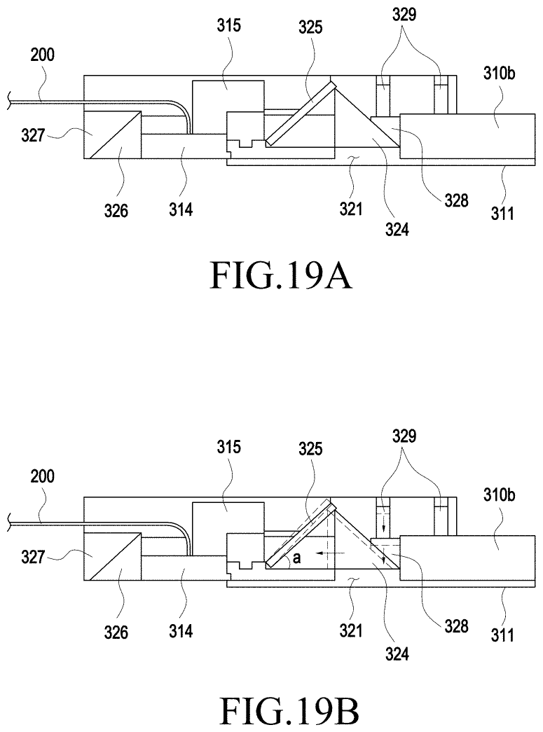

FIG. 19A illustrates positions and angles of a first light path changing member and a second light path changing member of a measuring jig according to various embodiments of the disclosure. FIG. 19B illustrates a position of a first light path changing member and an angle of a second light path changing member in a measuring jig being adjusted according to an embodiment.

Referring to FIGS. 19A and 19B, the measuring jig includes a position adjustment block 328, which may be disposed under the position adjuster 329. As the position adjuster 329 is tightened up, the position adjustment block 328 is moved down, pressurizing the first light path changing member 324 to move towards the measurement object.

The second light path changing member 325 may be provided, with a first portion (e.g., upper end) thereof placed over the top edge of the first light path changing member 324, a second portion (e.g., lower end) thereof may be rotatable on the jig body 310a and/or 310b. If the position of the first light path changing member 324 is changed, the first portion (e.g., upper end) of the second light path changing member 325 may be repositioned, with the second portion (e.g., lower end) of the second light path changing member 325 in fixed position, so that the angle (a) of the second light path changing member 325 may be adjusted.

For example, if the user tightens at least one position adjuster 329, the position adjustment block 328 is moved down, pressurizing the first light path changing member 324. The first light path changing member 324 pressurized by the position adjustment block 328 is moved towards the measurement object 200, so that the angle of the second light path changing member 325 from the support 310a and/or 310b may increase. If the angle of the second light path changing member 325 increases, the traveling direction of the light incident from the direction of the measurement object to the second light path changing member 325 may be changed, adjusting the distance of the focus forming on the optical module 325 and/or light quantity.

Since the first light guide 320a is positioned opposite the second light guide 320b with respect to the measurement object, the light traveling path of the first light guide 320a and the light traveling path of the second light guide 320b may also be positioned opposite with respect to the measurement object.

The first light guide 320a and the second light guide 320b may be configured to be symmetric with each other with respect to the measurement object. For example, the first light path changing member 324 and the second light path changing member 325 included in the first light guide 320a may form axial symmetry with the first light path changing member 324 and second light path changing member 325 included in the second light guide 320b, along the length direction of the measurement object 200 from the center of the measurement object 200.

According to an embodiment, a measuring jig may include a jig body including at least one light guide and a lighting unit disposed adjacent to a first surface of the jig body, wherein the light guide includes an opening formed in the first surface of the jig body, a first light path changing member configured to change a traveling path of light provided from the lighting unit through the opening, and a second light path changing member configured to transmit the light provided from the lighting unit and incident from a first direction and change a traveling path of light incident from a second direction.

The light incident from the second direction to the second light path changing member may include at least one of light refracted by the measurement object, light reflected by the measurement object, and light transmitted through surroundings of the measurement object.

Light refracted by the first light path changing member may be designed to pass through the second light path changing member to a side surface of the measurement object.

The first light path changing member may include a prism, and the second light path changing member may include a semi-transparent mirror.

The jig body may be a rectangular light guide including a through hole.

The light guide may include a first light guide formed along a side around the through hole and a second light guide formed adjacent to the first light guide, along another side around the through hole.

The light guide may include a first light guide formed along a side around the through hole and a third light guide formed opposite the first light guide with respect to the through hole.

The light guide may be formed in each of four different portions of the jig body around the through hole.

The light guide may include a first light guide, a second light guide formed adjacent to the first light guide along another side around the through hole, a third light guide formed opposite the first light guide with respect to the through hole, and a fourth light guide formed opposite the second light guide with respect to the through hole.

The jig body may include a first jig body including a first light guide and a second jig body spaced apart from the first jig body and including a second light guide.

Each of the first light guide and the second light guide may further include a third light path changing member configured to change a traveling path of light provided from a second lighting unit.

The measuring jig may further comprise at least one protrusion protruding from the jig body.

The measuring jig may further include at least one position adjuster.

The measuring jig may further comprise at least one side support member configured to restrict movement of the measurement object when the measurement object is mounted.

The side support member may be configured to be slidable along a length direction of the second light path changing member.

According to an embodiment, a measuring jig may include a jig body including a through hole and a light guide disposed around at least a portion of the through hole and a lighting unit disposed adjacent to a first surface of the jig body, wherein the light guide includes an opening formed in the first surface of the jig body, a first light path changing member for changing a traveling path of light provided from the lighting unit through the opening, and a second light path changing member for transmitting light provided from the lighting unit and incident from a first direction and changing a traveling path of light incident from a second direction.

The measuring jig may further include at least one protrusion protruding from the jig body to the through hole.

The protrusion may include a plurality of protrusions.

Light refracted by the first light path changing member may be designed to pass through the second light path changing member to a side surface of the measurement object.

The measuring jig may include, as the light guide, a first light guide formed along a side around the through hole and a second light guide formed adjacent to the first light guide, along another side around the through hole.

The light guide may include a first light guide formed along a side around the through hole and a third light guide formed opposite the first light guide with respect to the through hole.

The light guide may be formed in each of four different portions of the jig body around the through hole.

The light guide may include a first light guide, a second light guide formed adjacent to the first light guide along another side around the through hole, a third light guide formed opposite the first light guide with respect to the through hole, and a fourth light guide formed opposite the second light guide with respect to the through hole.

The lighting unit may be disposed along the periphery of the through hole.

The lighting unit may form a closed loop along the periphery of the through hole.

The first light path changing member may include a prism, and the second light path changing member may include a semi-transparent mirror.

A cover may be provided to prevent the light incident through the opening from leaking to the outside of the jig body.

At least one side support member may be provided along the periphery of at least a portion of the through hole.

The side support member may include a first side support member disposed on a side around the through hole and a second side support member disposed along another side around the through hole.

The side support member may be integrated formed from the jig body.

According to an embodiment, a measuring jig may include a first jig including a first light guide, a second jig body spaced apart from the first jig body and including a second light guide, and a first lighting unit disposed on a first surface of the first jig body and the second jig body, wherein the first light guide and the second light guide are disposed to face each other on two opposite sides of a measurement object when the measurement object is mounted, wherein each of the first light guide and the second light guide includes an opening formed in the first surface of the first jig body and the second jig body, a first light path changing member for changing a traveling path of light provided from the first lighting unit, and a second light path changing member for transmitting light provided from the first lighting unit and incident from a first direction and changing a traveling path of light incident from a second direction.

Each of the first light guide and the second light guide may further include a third light path changing member configured to change a traveling path of light provided from a second lighting unit.

According to an embodiment, a measuring device for a 3D measurement object may include a measuring jig, a platform for placing the measuring jig, an optical tower unit spaced apart from the platform by a predetermined distance, disposed to face the measuring jig, and including an optical module for obtaining an image of the measurement object, and a monitor unit displaying the image captured for the measurement object disposed on the measuring jig, wherein the measuring jig may include a jig body including a through hole and a light guide disposed around at least a portion of the through hole and a first lighting unit disposed adjacent to a first surface of the jig body, and wherein the platform may include a second lighting unit disposed under the through hole of the measuring jig.

The optical module may obtain both a plan image and a side image of the measurement object, and the monitor unit may output a 2D image including the plan image and side image of the measurement object.

The platform may further include a conveyor member to move the measuring jig in a planar direction.

The light guide may include an opening formed in a first surface of the jig body, a first light path changing member for changing a traveling path of light provided from the lighting unit through the opening, and a second light path changing member for transmitting at least part of light provided from the lighting unit and changing a traveling path of part of light reflected by the measurement object.

The measuring jig may further include at least one protrusion protruding from the jig body to the through hole.

According to an embodiment, a measuring jig may include a jig body including a through hole, at least one protrusion protruding toward the through hole, and a light guide disposed to surround at least a portion of the through hole and a lighting unit disposed adjacent to a first surface of the jig body, wherein the light guide includes an opening formed in the first surface of the jig body and to which light provided from the lighting unit is incident, a third opening formed in a second surface facing away from the first surface and from which at least one of the light incident to a side surface of the measurement object seated on the protrusion and the light reflected from the measurement object exits, a first light path changing member disposed on a traveling path of light between the opening and the third opening and refracting the light incident through the opening to a side surface of the measurement object, and a second light path changing member disposed behind the first light path changing member along the traveling path of the light incident through the opening and refracting at least one of the light incident to a side surface of the measurement object seated on the protrusion and the light reflected from the measurement object to the third opening.

A fourth opening may be formed in an inner surface of the jig body between the first surface and the second surface.

The fourth opening included in the first light guide may be designed to have, incident thereto,

Light transmitted through the second light path changing member included in the first light guide and reflected on a side surface of the measurement object and the light provided from the third light guide and transmitted through the measurement object.

The fourth opening included in the first light guide may be designed to have, incident thereto, the light transmitted through the second light path changing member included in the first light guide and reflected on a side surface of the measurement object and the light provided from the third light guide and transmitted through the measurement object.

According to an embodiment, a measuring jig may include a first jig body including a first light guide, a second jig body spaced apart from the first jig body and including a second light guide, and a first lighting unit disposed on a first surface of the first jig body and the second jig body, wherein the first light guide and the second light guide are disposed to face each other on two opposite sides of a measurement object when the measurement object is mounted, wherein each of the first light guide and the second light guide includes a through hole formed in the first surface of the first jig body and the second jig body, a first light path changing member for changing a traveling path of light provided from the first lighting unit through the through hole, and a second light path changing member for transmitting light provided from the first lighting unit and incident from a first direction and changing a traveling path of light incident from a second direction.

The light incident from the second direction to the second light path changing member may include at least one of light refracted by the measurement object, light reflected by the measurement object, and light transmitted through surroundings of the measurement object.

Each of the first light guide and the second light guide may further include a third light path changing member configured to change a traveling path of light provided from a second lighting unit.

At least one position adjuster may be provided for adjusting the position of the first light path changing member to adjust the angle of the second light path changing member.

At least one side support member may be provided for restricting movement of the measurement object when the measurement object is mounted. The side support member may be configured to be slidable along a length direction of the second light path changing member.

According to the above-described embodiments of the disclosure, a measuring jig and a measuring device including the measuring jig may place a measurement object firmly in position regardless of the size of the measurement object, thereby allowing quick and convenient measurement.

According to the above-described embodiments of the disclosure, a measuring jig and a measuring device including the measuring jig may simultaneously measure a plan image and a side image of a 3D measurement object, thereby allowing for quick and precise measurement of the measurement object.

While the disclosure has been shown and described with reference to certain embodiments thereof, it will be apparent to those of ordinary skill in the art that various changes in form and detail may be made thereto without departing from the spirit and scope of the disclosure as defined by the following claims and any equivalents thereof.

What is claimed is:

1. A measuring jig, comprising:
a jig body including at least one light guide; and
a lighting unit disposed adjacent to a first surface of the jig body, wherein the light guide includes:
an opening formed in the first surface of the jig body;
a first light path changing member configured to change a traveling path of light provided from the lighting unit through the opening; and
a second light path changing member configured to transmit the light provided from the lighting unit and incident from a first direction and change a traveling path of light incident from a second direction.

2. The measuring jig of claim 1, wherein the light incident from the second direction to the second light path changing member includes at least one of light refracted by a measurement object, light reflected by the measurement object, or light transmitted through surroundings of the measurement object.

3. The measuring jig of claim 1, wherein light refracted by the first light path changing member passes through the second light path changing member to a side surface of a measurement object.

4. The measuring jig of claim 1, wherein the first light path changing member includes a prism, and
wherein the second light path changing member includes a semi-transparent mirror.

5. The measuring jig of claim 1, wherein the jig body is a rectangular jig body including a through hole thereinside.

6. The measuring jig of claim 5, wherein the light guide further includes a first light guide formed along a first side around the through hole and a second light guide formed adjacent to the first light guide, along a second side around the through hole.

7. The measuring jig of claim 5, wherein the light guide further includes a first light guide formed along a first side around the through hole and a third light guide formed opposite the first light guide with respect to the through hole.

8. The measuring jig of claim 5, wherein the light guide is formed in each of four different portions of the jig body around the through hole.

9. The measuring jig of claim 8, wherein the light guide includes:
a first light guide;
a second light guide formed adjacent to the first light guide along another side around the through hole;
a third light guide formed opposite the first light guide with respect to the through hole; and
a fourth light guide formed opposite the second light guide with respect to the through hole.

10. The measuring jig of claim 1, wherein the jig body includes:
a first jig body including a first light guide; and
a second jig body spaced apart from the first jig body and including a second light guide.

11. The measuring jig of claim 10, wherein each of the first light guide and the second light guide includes a third light path changing member configured to change a traveling path of light provided from a second lighting unit.

12. The measuring jig of claim 1, further comprising at least one protrusion protruding from the jig body.

13. The measuring jig of claim 1, further comprising at least one position adjuster configured to adjust a position of the first light path changing member and to adjust an angle of the second light path changing member.

14. The measuring jig of claim 1, further comprising at least one side support member configured to restrict movement of a measurement object when the measurement object is mounted.

15. The measuring jig of claim 14, wherein the side support member is slidable along a length direction of the second light path changing member.

16. A measuring jig, comprising:
a jig body including a through hole and a light guide disposed around at least a portion of the through hole; and
a lighting unit disposed adjacent to a first surface of the jig body,
wherein the light guide includes:
an opening formed in the first surface of the jig body,
a first light path changing member for changing a traveling path of light provided from the lighting unit through the opening, and
a second light path changing member for transmitting light provided from the lighting unit and incident from a first direction, and changing a traveling path of light incident from a second direction.

17. The measuring jig of claim 16, wherein the light incident from the second direction includes at least one of light refracted by a measurement object, light reflected by the measurement object, or light transmitted through surroundings of the measurement object.

18. The measuring jig of claim 16, wherein the first light path changing member includes a prism, and
wherein the second light path changing member includes a semi-transparent mirror.

19. The measuring jig of claim 16, further comprising a protrusion protruding from the jig body.

20. A measuring jig, comprising:
a first jig body including a first light guide;
a second jig body spaced apart from the first jig body and including a second light guide; and
a lighting unit disposed on first surfaces of the first jig body and the second jig body,
wherein the first light guide and the second light guide are disposed to face each other on two opposite sides of a measurement object when the measurement object is mounted,
wherein each of the first light guide and the second light guide includes:
an opening formed in the first surfaces of the first jig body and the second jig body,
a first light path changing member for changing a traveling path of light provided from the lighting unit, and
a second light path changing member for transmitting light provided from the lighting unit and incident from a first direction, and changing a traveling path of light incident from a second direction.
